(19) United States
(12) Patent Application Publication
(10) Pub. No.: US 2026/0322686 A1
(43) Pub. Date: Oct. 15, 2026

(54) SENDING AND RECEIVING A NETWORK SLICE SERVICE PROFILE

(71) Applicant: Telefonaktiebolaget LM Ericsson (publ), Stockholm (SE)

(72) Inventors: Mitu VERMA, Athlone (IE); Robert TÖRNKVIST, Karlskrona (SE)

(21) Appl. No.: 19/101,380

(22) PCT Filed: Aug. 15, 2022
(86) PCT No.: PCT/EP2022/072769

§ 371 Date: Feb. 5, 2025

(51) Int. Cl. H04L 41/0806; H04L 12/14

(52) U.S. Cl. CPC H04L 41/0806; H04L 12/1407

(57) ABSTRACT

Methods and apparatus are provided. In an example, a method in a first network node of monitoring network slice usage is provided. The method includes receiving a service profile for a network slice, the service profile identifying a plurality of sets of one or more conditions and a plurality of traffic profiles, wherein individual traffic profiles are associated with a respective set of one or more conditions, and receiving usage information identifying usage of the network slice by a consumer of the network slice. The method also includes determining whether the usage of the network slice under one or more conditions of the usage of the network slice satisfies the traffic profile associated with the set of one or more conditions that correspond to the one or more conditions of the usage of the network slice.

### TECHNICAL FIELD

Example embodiments of this disclosure relate to sending and/or receiving a service profile, such as for example as part of monitoring network slice usage.

### BACKGROUND

A network slice in a 5th generation (5G) wireless telecommunications network is an independent end-to-end logical network that runs on a shared physical infrastructure, capable of providing a negotiated service quality.

The network slicing management functions of 5G network, such as the Network Slice Management Function (NSMF), Network Slice Subnet Management Function (NSSMF) and Communication Service Management Function (CSMF), are responsible for the end-to-end creation, management, and orchestration of network slice instances and network slice subnet instances.

For provisioning of a network slice instance (NSI), the 3rd Generation Partnership Project (3GPP) have specified an allocateNsi operation. The allocateNsi operation is invoked by a service consumer in order to request the provider to allocate a network slice instance that fulfills its network slice related requirements.

When allocateNsi operation is invoked, the requirements specified in the allocateNsi operation are compared against the actual capabilities of all candidate NSIs by the provider. If an existing NSI can be found, for example with the right coverage and with good enough latency, it is eligible for allocation. In case there is no NSI matching the requirements, a new NSI is created with sufficient capabilities, if there is capacity for the required Network Slice Subnet Instances (NSSIs).

The input parameters of the allocateNsi request are detailed in table 1 below:

TABLE 1
Source TS 28.531, Release 17, Section 6.5.1.2

| Parameter | Support | Information Type/Legal | |
|---|---|---|---|
| Name | Qualifier | Values | Comment |
| attributeListIn | M | LIST OF SEQUENCE<attribute | This parameter specifies the network slice |
| | | name, attribute | related requirements defined in |
| | | value> | ServiceProfile in Clause 6.3.3 in TS |
| | | | 28.541. |

According to clause 6.3.3 of 3GPP TS 28.541 [2], “ServiceProfile” represents the properties of network slice related requirements that should be supported by the NetworkSlice instance in 5G network.

Attributes of “ServiceProfile” that represents network slice related requirements are listed in table below:

TABLE 2
TS 28.541 Release 17, Section 6.3.3, Attributes of “ServiceProfile”

| | Support | | | | |
|---|---|---|---|---|---|
| Attribute name | Qualifier | isReadable | isWritable | isInvariant | isNotifyable |
| serviceProfileId | M | T | F | T | T |
| pLMNInfoList | O | T | F | F | T |
| maxNumberofUEs | O | T | T | F | T |
| coverageArea | O | T | T | F | T |
| latency | O | T | T | F | T |
| uEMobilityLevel | O | T | T | F | T |
| networkSliceSharingIndicator | O | T | T | F | T |
| sST | M | T | T | F | T |
| availability | O | T | T | F | T |
| delayTolerance | O | T | T | F | T |
| dLDeterministicComm | O | T | T | F | T |
| uLDeterministicComm | O | T | T | F | T |
| dLThptPerSlice | O | T | T | F | T |
| dLThptPerUE | O | T | T | F | T |
| uLThptPerSlice | O | T | T | F | T |
| uLThptPerUE | O | T | T | F | T |
| dLMaxPktSize | O | T | T | F | T |
| uLMaxPktSize | O | T | T | F | T |
| maxNumberofPDUSessions | O | T | T | F | T |
| kPIMonitoring | O | T | T | F | T |
| userMgmtOpen | O | T | T | F | T |
| v2XCommModels | O | T | T | F | T |
| termDensity | O | T | T | F | T |
| activityFactor | O | T | T | F | T |
| uESpeed | O | T | T | F | T |
| jitter | O | T | T | F | T |
| survivalTime | O | T | T | F | T |
| radioSpectrum | O | T | T | F | T |
| reliability | O | T | T | F | T |
| maxDLDataVolume | O | T | T | F | T |
| maxULDataVolume | O | T | T | F | T |
| nBIoT | O | T | T | F | T |
| synchronicity | O | T | T | F | T |
| positioning | O | T | T | F | T |
| sliceSimultaneousUse | O | T | T | F | T |
| energyEfficiency | O | T | T | F | T |

According to 3GPP TS 28.202 [5], CEF (Charging Enablement Function) collects charging information per NSI Creation, Modification and Termination. This means that when a NSI is created, modified or terminated, then this information is conveyed to CEF. This is depicted in FIG. 1, from 3GPP TS 28.202, clause 4.2.2., which shows an example of a CEF collecting Network Slice Management Charging Information.

When an allocateNsi operation results in the creation of a NSI, then the provider, acting as an MnS producer (management service producer), informs CEF, as shown in FIG. 1. Based on the CEF configuration, NSI creation/modification/termination information is sent to a Charging Function (CHF) to take necessary action by CHF, such as for example discounted charging for users who are sharing their Network Slice.

According to 3GPP TS 28.202, clause 5.1.3, the following list of information elements of the “ServiceProfile” are identified to be used by CHF:
ServiceProfile identifier.
S-NSSAI(s).
SST.
Latency.
Resource Sharing Level.
Availability.
Jitter.
Reliability.
Maximum Number of UEs.
Coverage Area.
Max Number of PDU sessions,
UE mobility Level.
Delay Tolerance.
UL/DL Throughput Per UE.
UL/DL Throughput Per UE.
UL/DL Throughput Per Slice.
KPI Monitoring.
Supported Access Technology.
V2X Communication Mode

### SUMMARY

Examples of this disclosure may have certain advantages. For example, examples of this disclosure may allow consumers using a network slice to provide traffic profile conditions of their choice for conditional charging of network slices. A network operator or network slice provider may charge for this feature. Network slice consumers may be able to configure/modify/delete traffic profile conditions for network slice conditional charging.

One aspect of the present disclosure provides a method in a first network node of monitoring network slice usage. The method comprises receiving a service profile for a network slice, the service profile identifying a plurality of sets of one or more conditions and a plurality of traffic profiles, wherein individual traffic profiles are associated with a respective set of one or more conditions, and receiving usage information identifying usage of the network slice by a consumer of the network slice. The method also comprises determining whether the usage of the network slice under one or more conditions of the usage of the network slice satisfies the traffic profile associated with the set of one or more conditions that correspond to the one or more conditions of the usage of the network slice.

Another aspect of the present disclosure provides a method of sending a service profile. The method comprises receiving, at a second network node, a notification of allocation of a network slice and a service profile for the network slice, the service profile identifying a plurality of sets of one or more conditions and a plurality of traffic profiles, wherein individual traffic profiles are associated with a respective set of one or more conditions, and sending, by the second network node, the service profile and usage information identifying usage of the network slice by a consumer of the network slice to a first network node. The method also comprises receiving, at the first network node, the service profile for the network slice and the usage information, and determining, by the first network node whether the usage of the network slice under one or more conditions of the usage of the network slice satisfies the traffic profile associated with the set of one or more conditions that correspond to the one or more conditions of the usage of the network slice.

An additional aspect of the present disclosure provides apparatus in a first network node for monitoring network slice usage. The apparatus comprises a processor and a memory. The memory contains instructions executable by the processor such that the apparatus is operable to receive a service profile for a network slice, the service profile identifying a plurality of sets of one or more conditions and, for individual sets of one or more conditions, a traffic profile for traffic in the network slice under the one or more conditions, receive usage information identifying usage of the network slice by a consumer of the network slice, and determine whether the usage of the network slice under one or more conditions of the usage of the network slice satisfies the traffic profile for a set of one or more conditions corresponding to the one or more conditions of the usage of the network slice.

A further aspect of the present disclosure provides a system comprising a first network node and a second network node. The system is configured to receive, at the second network node, a notification of allocation of a network slice and a service profile for the network slice, the service profile identifying a plurality of sets of one or more conditions and, for individual sets of one or more conditions, a traffic profile for traffic in the network slice under the one or more conditions; send, by the second network node, the service profile and usage information identifying usage of the network slice by a consumer of the network slice to a first network node; receive, at the first network node, the service profile for the network slice and the usage information; and determine, by the first network node whether the usage of the network slice under one or more conditions of the usage of the network slice satisfies the traffic profile associated with the set of one or more conditions that correspond to the one or more conditions of the usage of the network slice.

A still further aspect of the present disclosure provides apparatus in a first network node for monitoring network slice usage. The apparatus is configured to receive a service profile for a network slice, the service profile identifying a plurality of sets of one or more conditions and, for individual sets of one or more conditions, a traffic profile for traffic in the network slice under the one or more conditions, receive usage information identifying usage of the network slice by a consumer of the network slice, and determine whether the usage of the network slice under one or more conditions of the usage of the network slice satisfies the traffic profile for a set of one or more conditions corresponding to the one or more conditions of the usage of the network slice.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of a Charging Enablement Function (CEF) collecting Network Slice Management Charging Information;

FIG. 2 shows an example of a variety of communication services provided by multiple network slices;

FIG. 3 is a flow chart of an example of a method in a first network node of monitoring network slice usage;

FIG. 4 is a flow chart of an example of a method of sending a service profile;

FIG. 5 shows another example of a system in which examples of the method of FIG. 4 may be implemented;

FIG. 6 shows another example of a system in which examples of the method of FIG. 4 may be implemented;

FIG. 7 shows another example of a system in which examples of the method of FIG. 4 may be implemented;

FIG. 8 shows an example of a system for Network Slice Instance (NSI) allocation;

FIG. 9 shows a schematic diagram of an apparatus for monitoring network slice usage.

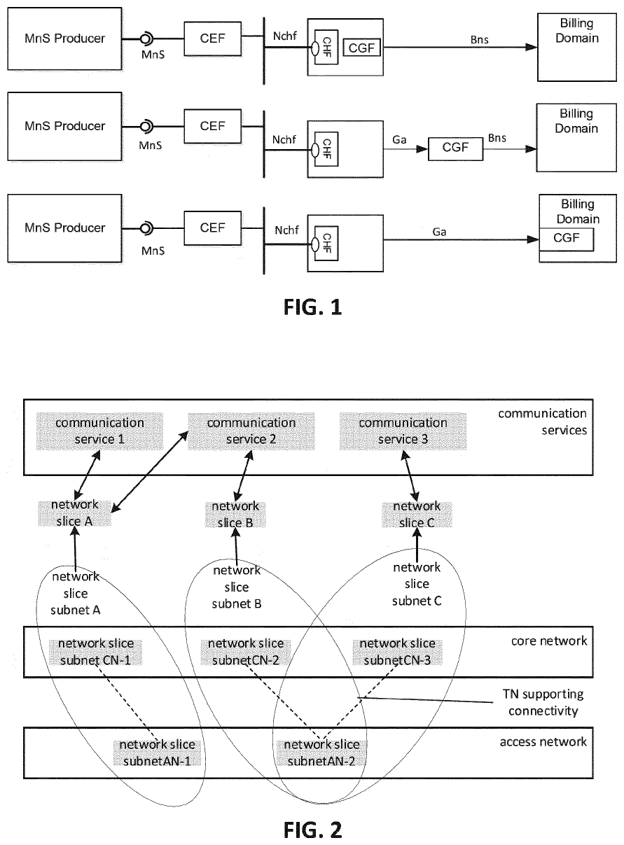

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Operators of wireless communication networks, such as for example 4G and/or 5G networks, can offer variety of services to its subscribers. For example, 5G systems are expected to be able to provide optimized support for a variety of different communication services, different traffic loads, and different types of end users. These communication services may be provided by multiple network slices as illustrated in FIG. 2, from TS 28.530 section 4.1.3, which shows an example of a variety of communication services provided by multiple network slices.

Operators would like to be able to charge for using the underlying network infrastructure (e.g. by network slices) based on conditions for offering different communication services, in order to maximize the monetization of these communication services. An operator can use various analytics to predict and understand subscribers' traffic patterns and load on the network. However, these analytics do not take inputs directly from a Network Slice Management Services Consumer (NSMS_Consumer). The NSMS_Consumer may have knowledge of its own traffic pattern and usage. Inputs directly from NSMS_Consumer could assist in optimization and monetization of network slices, by encouraging conditional charging of these network slices.

At present there is no formal or established mechanism for a NSMS_Consumer to give input or feedback regarding its traffic pattern to an operator, and accordingly share its preference for conditional charging of network slices. In particular, it is currently not possible for the following:
A network slice provider receives input from the network slice consumer, for example during network slice allocation, on expected usage that can influence the rate and cost.
Network slice consumers indicating the conditions for charging of network slices to the provider.
The provider verifying that the actual usage of a network slice falls within the expected usage (e.g. as indicated by the consumer) and evaluate if these would impact the rate and cost.

In an example, consider a wireless communications network operator (a NSMS_Provider) that offers a “Massive-IoT (Internet of Things)” communication service in a given geographical area. A network slice may be used in this example to provide the service. Various users in this area (e.g. companies and/or businesses) may already be using a Massive-IoT communication service to realize their business objectives, and may understand patterns of their traffic pattern and load.

An example NSMS_Consumer may use the Massive-IoT service in one or more of the following example ways:
NSMS_Consumer may have their business performed mostly in US time zone weekdays (Monday to Friday) from 9 am to 6 pm. This means that the NSMS_Consumer will have the most traffic and the strictest requirement on latency (e.g. lowest latency) during these business hours.
NSMS_Consumer's usage and requirements on latency may vary over the year, for example the requirements may be lower during summer, over holidays, etc.
During a few weeks every year, the NSMS_Consumer consolidates and validates inputs from various IoT devices as part of an auditing exercise, so during this period the NSMS_Consumer will require extra capacity.

Considering the above scenarios, the NSMS_Consumer varying usage and requirements may allow the consumer to negotiate the cost with the provider, and the cost could vary. For example, sometimes it could be charged at a premium rate, whereas at other times it may be charged at discounted price based on conditions provided by the consumers of those network slices.

In some examples, if a consumer is provided discounted tariffs by a provider depending on conditions provided by them, then they could agree to pay premium price when their requirements are higher (higher capacity, lower latency, more connected devices, and/or higher bandwidth etc.).

Examples of this disclosure may provide a technical process for monitoring usage of a network slice by a network slice consumer under different conditions. For example, a service profile for a network slice may specify a different traffic usage profile for different conditions, and the network may monitor/determine whether the actual monitored traffic usage fits the profile for the current conditions. Thus, for example, the service profile may indicate one traffic profile (e.g. capacity, number of connected devices, bandwidth etc.) for one set of conditions (e.g. time, days, dates, geographical area etc.), and a different traffic profile for a different set of conditions. This way, for example, the provider may monitor and determine whether the actual usage during conditions that correspond to those of one of the traffic profiles (e.g. at the same time, in the same area etc) does not exceed the specified traffic profile for those conditions.

One example of how this could be used is that the consumer may be able to negotiate a lower cost tariff if, for example, the traffic profile has reduced usage at certain times, is area restricted, etc. This may also enable the network slice provider to charge the consumer if the actual usage exceeds the traffic profile for the conditions. For example, the consumer may have more connected devices and/or have a higher bandwidth usage than specified in the service profile, and/or the consumer may use devices and bandwidth outside of a specified area. In these cases, the operator may continue to allow the consumer to use the network slice (e.g. outside of the specified area) but may trigger a surcharge.

Below are provided some examples of one or more features that may be included in embodiments of this disclosure.

According to 3GPP TS 28.541, section 6.3.3.1, a Service Profile (which represents the properties of network slice related requirement(s) that should be supported by a requested Network Slice instance in 5G network) has no existing parameter which can indicate that conditional charging is requested, and/or consumer provided traffic profile conditions, at the time of Network Slice Instance allocation. Therefore, example embodiments of this disclosure propose to introduce an indicator, referred to in some examples a “Network Slice Conditional Charging Indicator,” which will be provided by a network slice consumer requesting a NSI, and used by a network node (e.g. Network Slice Management Function, NSMF) during network slice allocation, usage monitoring and/or charging. Additionally or alternatively, for example, a set of traffic profiles and conditions, collectively referred to in some examples as “traffic profile condition,” which will indicate sets of conditions and associated traffic profiles (e.g. expected usage of the network slice). For example, which when satisfied, the traffic profiles and conditions may allow a network slice' to be charged to the consumer differently based on the profiles and conditions provided, and/or may allow the consumer to be surcharged if the traffic profile is exceeded for the corresponding conditions.

A new network function (NF), named as NSCCMF (Network Slice Conditional Charging Management Function), is proposed in a 5G network in some examples. This newly proposed NF will store information relating to all network slices being conditionally charged (e.g. having the “networkSliceConditionalChargingIndicator” attribute value set, or “Network Slice Conditional Charging Indicator” referred to above), such as for example a service profile that includes traffic profiles and corresponding sets of condition(s).

The newly proposed NF, NSCCMF, may in some examples provide one or more of the following services, which are illustrative examples:
ConditionalChargingNsi (Get): To fetch information on all Network Slices from NSCCMF whose conditions are matched with a traffic profile condition ‘trafficProfileCondition’. NSMS_Provider Subscription may use ConditionalChargingNsi Get API during AllocateNsi operation.
ConditionalChargingNsi Create (POST): To insert a new entry into NSCCMF for newly created Network Slices with ‘networkSliceConditionalChargingIndicator’ attribute value set and corresponding traffic profiles and sets of condition(s) stored in ‘trafficProfileCondition’. NSMS_Provider may use ConditionalSharingNsi Create (POST) API during AllocateNsi operation.
ConditionalChargingNsi (Delete): To remove entry of Network Slices from NSCCMF with ‘networkSliceConditionalChargingIndicator’ attribute value set and corresponding traffic profiles and conditions stored in ‘trafficProfileCondition’. NSMS_Provider may use ConditionalChargingNsi Delete API during DeallocateNsi operation.
ConditionalChargingNsi Update (Put): To modify existing conditions and/or traffic profiles stored in ‘trafficProfileCondition’ attribute. NSMS_Provider may use ConditionalChargingNsi Update (Put) API during AllocateNsi operation.
ConditionalChargingNsi Subscription (Subscribe/Notify): NSMS_Provider would subscribe to events from NSCCMF using this interface.

A network exposure function (NEF) may expose these new REST based APIs so that consumers can add/modify/delete conditions stored in ‘trafficProfileCondition’ for the Network Slice with ‘networkSliceConditionalChargingIndicator’. This new REST interface can in some examples be hosted by NSCCMF, and NEF will act as Proxy. Any change in conditions and/or traffic profiles may in some examples need to pass feasibility check procedure in NSMS_Provider.

In some examples, the parameters “NetworkSlice Conditional Charging Indicator” and “trafficProfileCondition” may be passed to the Charging function (CHF). The CHF may perform appropriate charging based on the conditions and traffic profiles provided, and may in some examples also perform surcharging based on whether the traffic profile is exceeded.

The above implementation is merely an example, and in other implementations different functions and processes may be used to achieve similar purposes for one or more of these functions. In addition, in some examples, instead of a new NF an existing NF may be used to implement one or more of these functions.

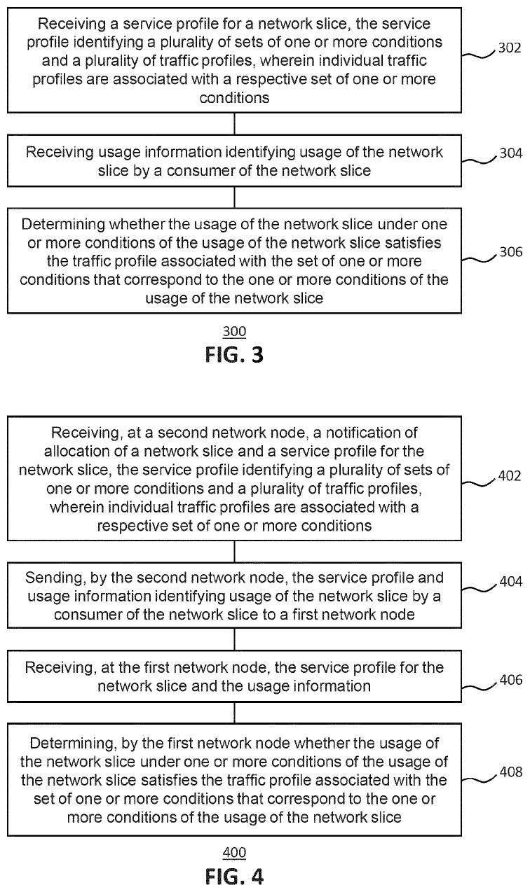

FIG. 3 is a flow chart of an example of a method 300 in a first network node of monitoring network slice usage. The first network node may be any suitable node in a network (e.g. 4G and/or 5G network or core network), such as a Charging Function (CHF) in some examples. The method 300 comprises, in step 302, receiving a service profile for a network slice. The service profile identifies a plurality of sets of one or more conditions and a plurality of traffic profiles, wherein individual traffic profiles are associated with a respective set of one or more conditions. That is, for example, each set of condition(s) may indicate the traffic profile (e.g. expected usage of the network slice) that the consumer expects during usage of the network slice under certain condition(s), e.g. times, dates, days, areas and/or one or more other conditions. The expected usage may indicate for example the number of connected devices, data usage, bandwidth, and/or any other traffic or device related information.

Step 304 of the method 300 comprises receiving usage information identifying usage of the network slice by a consumer of the network slice. In some examples, the service profile and/or usage information may be received from a second network node, such as for example a Charging Enablement Function (CEF). The usage information may be for example a charging data request from the CEF/second network node.

Step 306 of the method 300 comprises determining whether the usage of the network slice under one or more conditions of the usage of the network slice satisfies the traffic profile associated with the set of one or more conditions that correspond to the one or more conditions of the usage of the network slice. That is, for example, the first network node may, for the particular conditions of the usage, compare the usage with the traffic profile associated with corresponding conditions. For example, if the usage information corresponds to usage during certain times, then this usage is compared to the traffic information associated with a set of conditions that includes those times, to determine whether the usage satisfies the traffic profile (e.g. the usage indicates lower bandwidth than that specified in the traffic profile, etc.). Thus, in this way, for example, the usage of the network slice by a network slice consumer may be monitored according to different traffic profiles under different sets of one or more conditions.

In some examples, an action may be performed based on the determination in step 306. In one particular example, the method 300 may comprise performing a charging action based on the determination of whether the usage of the network slice under one or more conditions of the usage of the network slice satisfies the traffic profile for the set of one or more conditions corresponding to the one or more conditions of the usage of the network slice. Thus, for example, if the traffic profile is not satisfied but is instead exceeded, then the first network node may perform the charging action. Charging actions may include for example a surcharge action if the traffic profile is not satisfied but is instead exceeded, and/or a discount action for a consumer of the network slice if the usage is well below that indicated in the traffic profile, etc. In other examples, however, other actions other than charging actions may be taken following the determination in step 306. For example, other actions may include some restriction on the service provided to the consumer using the network slice.

The method 300 may in some examples comprise receiving, with the service profile, an indication that a charging action for a consumer of the network slice may be based on one or more of the sets of one or more conditions in the service profile. For example, the indication may be the “networkSliceConditionalChargingIndicator” or “Network Slice Conditional Charging Indicator” referred to above.

FIG. 4 is a flow chart of an example of a method 400 of sending a service profile. The method comprises, in step 402, receiving, at a second network node (e.g. a CEF), a notification of allocation of a network slice and a service profile for the network slice, the service profile identifying a plurality of sets of one or more conditions and a plurality of traffic profiles, wherein individual traffic profiles are associated with a respective set of one or more conditions. For example, as indicated above, each set of condition(s) may indicate the traffic profile (e.g. expected usage of the network slice) that the consumer expects during usage of the network slice under certain condition(s), e.g. times, dates, days, areas and/or one or more other conditions. The expected usage may indicate for example the number of connected devices, data usage, bandwidth, and/or any other traffic or device related information.

Step 404 of the method 400 comprises sending, by the second network node, the service profile and usage information identifying usage of the network slice by a consumer of the network slice to a first network node. Step 406 of the method 400 comprises receiving, at a first network node (e.g. CHF), the service profile for the network slice and the usage information. Step 408 of the method 400 comprises determining, by the first network node whether the usage of the network slice under one or more conditions of the usage of the network slice satisfies the traffic profile associated with the set of one or more conditions that correspond to the one or more conditions of the usage of the network slice. In some examples, the first network node is the network node referred to above with respect to the method 300 shown in FIG. 3, and thus in some examples the first network node may perform the method 300 of FIG. 3.

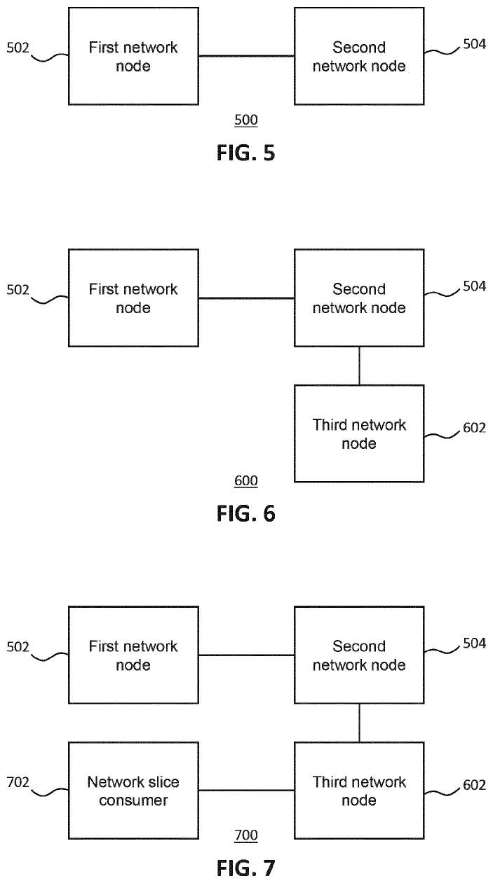

FIG. 5 shows an example of a system 500 in which examples of the method 400 of FIG. 4 may be implemented. The system 500 includes a first network node 502, such as for example the first network node referred to above with respect to the method 400 of FIG. 4, and may also in some examples be the first network node referred to above that performs the method 300 of FIG. 3. The system 500 also includes a second network node 504, such as for example the second network node referred to above with respect to the method 400 of FIG. 4.

In some examples, the method 400 includes sending, by the second network node (e.g. the second network node 504 shown in FIG. 5), the service profile to the first network node (e.g. the first network node 502) in a charging data request. Additionally or alternatively, for example, the method 400 may comprise sending, by the second network node to the first network node, with the service profile, an indication that a charging action for a consumer of the network slice may be based on one or more of the sets of one or more conditions in the service profile. The indication may be for example the “networkSliceConditionalChargingIndicator” or “Network Slice Conditional Charging Indicator” referred to above. The method 400 may in some examples comprise receiving, at the second network node, with the notification of allocation of a network slice, the indication that a charging action for a consumer of the network slice may be based on one or more of the sets of one or more conditions in the service profile.

The method 400 may in some examples sending, by the second network node to a network usage node (e.g. Management Data Analytics Service, MDAS), a subscription request to subscribe to usage information identifying usage of the network slice by a consumer of the network slice. The subscription request may be based on the service profile. The method 400 may also comprise receiving, from the network usage node, the usage information identifying usage of the network slice by a consumer of the network slice. In some examples, the information identifying the usage of the network slice by the consumer of the network slice is sent by the second network node to the first network node in a charging data request.

The method 400 may also in some examples comprises receiving, at a third network node (e.g. Network Slice Management Service, NSMS), a request for allocation of a network slice from a network slice consumer, the request identifying a service profile for a network slice, the service profile identifying a plurality of sets of one or more conditions and a plurality of traffic profiles, wherein individual traffic profiles are associated with a respective set of one or more conditions. The third network node may determine a network slice instance, NSI, for the request and send a notification identifying the network slice instance to the second network node, the notification identifying the service profile. The notification identifying the network slice instance may in some examples comprise the notification of allocation of the network slice. In some examples, the request contains the service profile, and/or the notification contains the service profile.

FIG. 6 shows another example of a system 600 in which examples of the method of FIG. 4 may be implemented. The system 600 includes the first network node 502 and second network node 504 shown in FIG. 5, and also includes a third network node 602, such as for example the third network node referred to above.

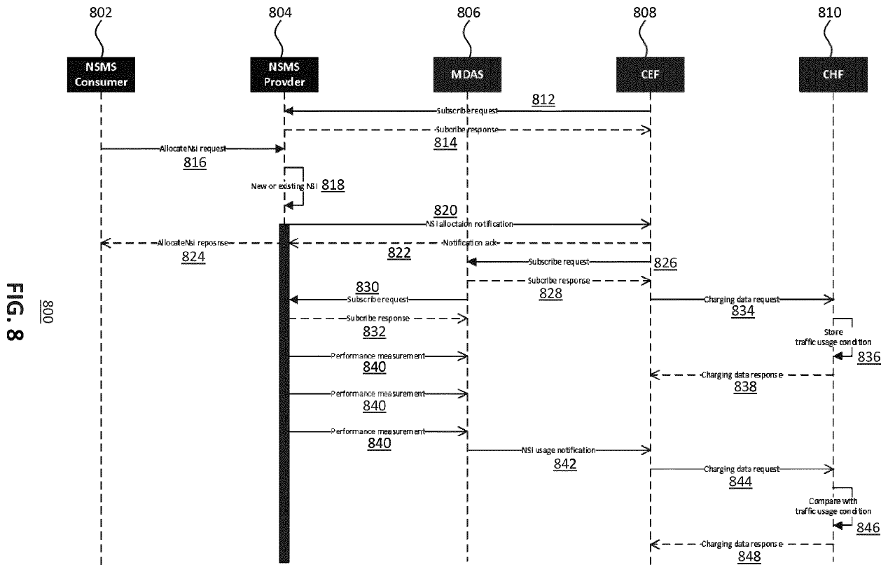

FIG. 7 shows another example of a system 700 in which examples of the method of FIG. 4 may be implemented. The system 700 includes the first network node 502 and second network node 504 shown in FIG. 5, and the third network node 602 shown in FIG. 6. In addition, the system 700 includes a network slice consumer 702, such as for example the network slice consumer referred to above.

The method 400 may also in some examples comprise receiving, at the third network node (e.g. the third network node 602) from the second network node, a subscription request for notifications of allocations of network slice instances, the subscription request based on the service profile, wherein sending the notification to the second network node is performed in response to the subscription request. Additionally or alternatively, in some examples, the method 400 may comprise sending, by the third network node, an allocation response to the network slice consumer (e.g. the network slice consumer 702), the allocation response identifying the network slice instance.

In some examples, the method 400 comprises sending, by the third network node towards the second network node, usage information identifying usage of the network slice by a consumer of the network slice. This may in some examples comprise sending the usage information to an aggregation node (e.g. Management Data Analytics Service, MDAS) for aggregation of the usage information before the aggregation node sends the aggregated usage information to the second network node.

The method 400 may in some examples comprise receiving, at the third network node with the request, an indication that a charging action for a consumer of the network slice may be based on one or more of the sets of one or more conditions in the service profile. Additionally or alternatively, in some examples, the method may comprise sending, by the third network node to the second network node, with the notification, an indication that a charging action for a consumer of the network slice may be based on one or more of the sets of one or more conditions in the service profile. The indication may be the “networkSliceConditionalChargingIndicator” or “Network Slice Conditional Charging Indicator” referred to above for example.

In some examples, the network slice consumer may send to the third network node a request for a network slice instance, the request identifying a service profile for a network slice, the service profile identifying a plurality of sets of one or more conditions and a plurality of traffic profiles, wherein individual traffic profiles are associated with a respective set of one or more conditions. The network slice consumer may in some examples also send with the request an indication that a charging action for the consumer of the network slice may be based on one or more of the sets of one or more conditions in the service profile. The network slice consumer may in some examples receive an allocation response from the third network node, the allocation response identifying the network slice instance.

Particular illustrative example embodiments will now be described.

FIG. 8 shows an example of a system 800, such as for example a system for Network Slice Instance (NSI) allocation. The system includes NSMS consumer 802, NSMS provider 804, MDAS 806, CEF 808 and CHF 810. In some examples, the system 800 may be a particular example of the system 700 shown in FIG. 7. Thus, for example, the NSMS consumer 802 may correspond to the network slice consumer 702, the NSMS provider 804 may correspond to the third network node 602, the CEF 808 may correspond to the second network node 504, and the CHF 810 may correspond to the first network node 502.

In this particular example, the system 800 exchanges messages and information as follows.
1. CEF 808 subscribes to NSI allocation events at the NSMS Provider (step 812)
2. NSMS Provider 804 confirms the subscription (step 814)
3. NSMS Consumer 802 request an allocation of an NSI including “traffic profile condition” and “NetworkSlice Conditional Charging Indicator” (step 816)
4. NSMS Provider 804 checks if the NSI requires a new or if it may reuse an existing network slice (step 818)
5. NSMS Provider 804 notifies the CEF 808 that a NSI has been allocated including “traffic profile condition”, “NetworkSlice Conditional Charging Indicator” and S-NSSAI (step 820)
6. CEF 808 confirms the reception of the notification (step 822)
7. NSMS Provider (804) confirms the allocation of the NSI including the S-NSSAI to be used for the UE to access the NSI (step 824)
8. CEF (808) subscribes to performance measurements from the MDAS 806 based on the S-NSSAI and the “traffic profile condition” (step 826)
9. MDAS (Management Data Analytics Service) 806 confirms the subscription of performance measurements (step 828)
10. MDAS 806 subscribes to performance measurements from the NSMS Provider 804 or network functions (step 830)
11. MDAS 806 subscription is confirmed (step 832)
12. CEF 808 sends a charging data request to the CHF 810 including “traffic profile condition”, “NetworkSlice Conditional Charging Indicator” and S-NSSAI (step 834)
13. CHF 810 stores the traffic profile condition” for the S-NSSAI, and generates a charging record of the event (step 836)
14. CHF 810 confirms charging recording using a charging data response (step 838)
15. Several performance reports are sent to MDAS 806, and aggregated at MDAS 806 (step 840)
16. MDAS 806 notifies the CEF 808 of the NSI usage based on the subscription made by the CEF 808 (step 842)
17. CEF 808 sends charging data request to the CHF 810 including the performance measurements for a S-NSSAI (step 844)
18. CHF 810 compares the performance measurement with the “traffic profile condition” and decides if there should be a surcharge or discount, the CHF 810 creates a charging record of the event and decision (step 846)
19. CHF 810 confirms charging recording using a charging data response (step 848)

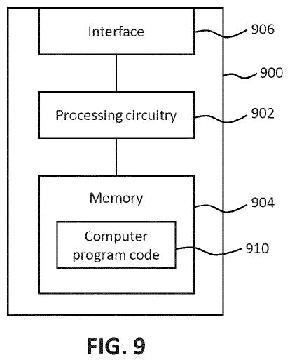

FIG. 9 is a schematic of an example of an apparatus 900 in a first network node for monitoring network slice usage. The apparatus 900 comprises processing circuitry 902 (e.g. one or more processors) and a memory 904 in communication with the processing circuitry 902. The memory 904 contains instructions, such as computer program code 910, executable by the processing circuitry 902. The apparatus 900 also comprises an interface 906 in communication with the processing circuitry 902. Although the interface 906, processing circuitry 902 and memory 904 are shown connected in series, these may alternatively be interconnected in any other way, for example via a bus.

In one embodiment, the memory 904 contains instructions executable by the processing circuitry 902 such that the apparatus 900 is operable/configured to receive a service profile for a network slice, the service profile identifying a plurality of sets of one or more conditions and, for individual sets of one or more conditions, a traffic profile for traffic in the network slice under the one or more conditions; receive usage information identifying usage of the network slice by a consumer of the network slice; and determine whether the usage of the network slice under one or more conditions of the usage of the network slice satisfies the traffic profile for a set of one or more conditions corresponding to the one or more conditions of the usage of the network slice. In some examples, the apparatus 900 is operable/configured to carry out the method 300 described above with reference to FIG. 3.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. GSM Association; Official Document NG.116—Generic Network Slice Template; Version 7.0; 17 Jun. 2022
2. 3GPP TS 28.541 Technical Specification; 3rd Generation Partnership Project; Technical Specification Group Services and System Aspects; Management and orchestration; 5G Network Resource Model (NRM); Stage 2 and stage 3; V17.4.0 (2021-09)
3. 3GPP TS 28.530 Technical Specification; 3rd Generation Partnership Project; Technical Specification Group Services and System Aspects; Management and orchestration; Concepts, use cases and requirements; V17.1.0 (2021-03)
4. 3GPP TS 28.531 Technical Specification; 3rd Generation Partnership Project; Technical Specification Group Services and System Aspects; Management and orchestration; Provisioning; V17.1.0 (2021-09)
5. 3GPP TS 28.202 Technical Specification; 3rd Generation Partnership Project; Technical Specification Group Services and System Aspects; Charging management; Network slice management charging in the 5G System (5GS); Stage 2; V16.1.0 (2020-12)
6. S5-211090; Rel-16 CR 28.531 Correction of NSI and NSSI Operations; 3GPP TSG-SA5 Meeting #135-e; Online, 25 Jan. 2021-3 Feb. 2021
7. 3GPP TSG-SA5 Meeting #134e; S5-206329d2; Revision of S5-206256rev3; Proposal on clarification of ServiceProfile representations; e-meeting

1. A method in a first network node of monitoring network slice usage, the method comprising:
receiving a service profile for a network slice, the service profile identifying a plurality of sets of one or more conditions and a plurality of traffic profiles, individual traffic profiles being associated with a respective set of one or more conditions;
receiving usage information identifying usage of the network slice by a consumer of the network slice; and
determining whether the usage of the network slice under one or more conditions of the usage of the network slice satisfies the traffic profile associated with the set of one or more conditions that correspond to the one or more conditions of the usage of the network slice.

2. The method of claim 1, wherein one or both of the service profile and the usage information is received from a second network node, wherein one or both:
the second network node is a Charging Enablement Function, CEF; and.
the first network node is a Charging Function, CHF.

3. (canceled)

4. (canceled)

5. The method of claim 1, further comprising performing a charging action based on the determination of whether the usage of the network slice under one or more conditions of the usage of the network slice satisfies the traffic profile for the set of one or more conditions corresponding to the one or more conditions of the usage of the network slice.

6. The method of claim 5, wherein the charging action comprises a surcharge action or a discount action for a consumer of the network slice.

7. The method of claim 1, further comprising receiving, with the service profile, an indication that a charging action for a consumer of the network slice may be based on one or more of the sets of one or more conditions in the service profile.

8. The method of claim 1, wherein the usage information comprises a charging data request.

9. A method of sending a service profile, the method comprising:
receiving, at a second network node, a notification of allocation of a network slice and a service profile for the network slice, the service profile identifying a plurality of sets of one or more conditions and a plurality of traffic profiles, individual traffic profiles being associated with a respective set of one or more conditions;
sending, by the second network node, the service profile and usage information identifying usage of the network slice by a consumer of the network slice to a first network node;
receiving, at the first network node, the service profile for the network slice and the usage information; and
determining, by the first network node whether the usage of the network slice under one or more conditions of the usage of the network slice satisfies the traffic profile associated with the set of one or more conditions that correspond to the one or more conditions of the usage of the network slice.

10. The method of claim 9, comprising sending, by the second network node, the service profile to the first network node in a charging data request.

11. The method of claim 9, further comprising sending, by the second network node to the first network node with the service profile, an indication that a charging action for a consumer of the network slice may be based on one or more of the sets of one or more conditions in the service profile.

12. The method of claim 9, further comprising receiving, at the second network node, with the notification of allocation of a network slice, an indication that a charging action for a consumer of the network slice may be based on one or more of the sets of one or more conditions in the service profile.

13. The method of claim 9, further comprising sending, by the second network node to a network usage node, a subscription request to subscribe to usage information identifying usage of the network slice by a consumer of the network slice.

14. (canceled)

15. (canceled)

16. The method of claim 13, further comprising:
receiving, from the network usage node, the usage information identifying usage of the network slice by a consumer of the network slice, wherein the information identifying the usage of the network slice by the consumer of the network slice is sent by the second network node to the first network node in a charging data request.

17. (canceled)

18. The method of claim 9, further comprising:
receiving, at a third network node, a request for allocation of a network slice from a network slice consumer, the request identifying a service profile for a network slice, the service profile identifying a plurality of sets of one or more conditions and a plurality of traffic profiles, wherein individual traffic profiles are associated with a respective set of one or more conditions;
determining, by the third network node, a network slice instance, NSI, for the request; and
sending, by the third network node, a notification identifying the network slice instance to a second network node, the notification identifying the service profile.

19. (canceled)

20. The method of claim 18, further comprising receiving, at the third network node from the second network node, a subscription request for notifications of allocations of network slice instances, the subscription request based on the service profile, wherein sending the notification to the second network node is performed in response to the subscription request.

21. The method of claim 18, further comprising sending, by the third network node, an allocation response to the network slice consumer, the allocation response identifying the network slice instance.

22. The method of claim 18, further comprising sending, by the third network node towards the second network node, usage information identifying usage of the network slice by a consumer of the network slice, wherein sending, by the third network node towards the second network node, the usage information comprises sending the usage information to an aggregation node for aggregation of the usage information before the aggregation node sends the aggregated usage information to the second network node.

23. (canceled)

24. (canceled)

25. The method of claim 18, further comprising one or both:
receiving, at the third network node with the request, an indication that a charging action for a consumer of the network slice may be based on one or more of the sets of one or more conditions in the service profile; and
sending, by the third network node to the second network node, with the notification, an indication that a charging action for a consumer of the network slice may be based on one or more of the sets of one or more conditions in the service profile.

26.-28. (canceled)

29. The method of claim 18, further comprising:
sending, by the network slice consumer to the third network node, a request for a network slice instance, the request identifying a service profile for a network slice, the service profile identifying a plurality of sets of one or more conditions and a plurality of traffic profiles, wherein individual traffic profiles are associated with a respective set of one or more conditions; and
sending, by the network slice consumer with the request, an indication that a charging action for the consumer of the network slice may be based on one or more of the sets of one or more conditions in the service profile.

30. (canceled)

31. The method of claim 29, comprising receiving, at the network slice consumer from the third network node, an allocation response, the allocation response identifying the network slice instance.

32.-34. (canceled)

35. An apparatus in a first network node for monitoring network slice usage, the apparatus comprising a processor and a memory, the memory containing instructions executable by the processor such that the apparatus is operable to:
receive a service profile for a network slice, the service profile identifying a plurality of sets of one or more conditions and, for individual sets of one or more conditions, a traffic profile for traffic in the network slice under the one or more conditions;
receive usage information identifying usage of the network slice by a consumer of the network slice; and
determine whether the usage of the network slice under one or more conditions of the usage of the network slice satisfies the traffic profile for a set of one or more conditions corresponding to the one or more conditions of the usage of the network slice.

36.-42. (canceled)
